(19) United States
(12) Patent Application Publication
(10) Pub. No.: US 2004/0164460 A1
(43) Pub. Date: Aug. 26, 2004

(54) Method for producing an article of plastics by injection molding

(75) Inventor: Kashichi Hirota, Hachioji-shi (JP)

Correspondence Address: COHEN, PONTANI, LIEBERMAN & PAVANE, 551 FIFTH AVENUE, SUITE 1210, NEW YORK, NY, 10176, US

(73) Assignee: Kyowa Electric and Chemical Co., Ltd., Tokyo (JP)

(21) Appl. No.: 10/785,296

(22) Filed: Feb. 23, 2004

(30) Foreign Application Priority Data
Feb. 9, 2003 (JP) 2003-309837

(51) Int. Cl. B29C 45/00

(52) U.S. Cl. 264/328.16; 264/338

(57) ABSTRACT

A method for producing an article made of plastics by an injection molding process is described. A movable die of a plastic-material injection molding die assembly is heated at a temperature of 50 to 70° C., or 60 to 95° C., and placed at a coating station to apply a liquid acrylic lacquer coating or urethane-based or epoxy-based coating on a molding surface of the movable die. Then, the movable die is moved into a drying chamber maintained at a temperature of 50 to 60° C., or 80 to 90° C., and placed in the drying chamber for 30 to 90 seconds, or 6 to 30 seconds, to semi-dry the coating applied on the molding surface. Subsequently, the movable die is connected to a fixed die of the die assembly to form a molding cavity. Then, a molten plastics material is injected into the molding cavity to produce an injection-molded plastics material product having a coated film of the coating.

### FIELD OF THE INVENTION

The present invention relates to method for producing an article made of plastics through an injection molding process, and more particularly to such an injection molding process for producing an article of plastics having a coating on its surface.

### BACKGROUND ART

Japanese Patent Publication No. 3264776 discloses a method of producing a molded article with a surface coating, in which a molding process using thermoplastic elastomer plastics material is performed in conjunction with a coating process. According to this conventional technique, a molded product with a surface coating can be obtained by applying a coating material on an ornamental surface of an injection-molding die which is in advance applied with a release agent, and injecting a thermoplastic elastomer plastics material into the die within 10 minutes, preferably within 5 minutes, after the application of the coating material. The plastics material to be injected is an olefin-based or styrene-based elastomer, and the coating material has 10 to 30 seconds of falling time based on a viscosity measurement method using a Ford Cup No. 4 according to the Japanese Industrial Standard JIS-K5400.

The process disclosed by the aforementioned Japanese patent is intended to use a coating material having a specific range of viscosity so as to prevent the film of the coating material from being disarranged by the flow of the injected plastics material. The inventors of the patent describe that a desirable result in actual experimental tests could be obtained by setting the time between the application of the coating material and the injection of the plastics material at about one minute. However, the plastics material which can be used in this conventional method is limited to a specific type having less than 5000 kg/cm² of bending elastic modulus according to the Japanese Industrial Standard JIS-K7203, specifically to an olefin-based thermoplastic elastomer or a styrene-based thermoplastic elastomer. Further, this process is essentially required to apply a release agent on the ornamental surface of the die.

### DISCLOSURE OF THE INVENTION

It is an object of the present invention to provide a method for producing an article made of plastics and having a surface coating through an injection molding process, capable of eliminating or significantly reducing restrictions on plastics material as compared to the conventional method to thereby eliminate the need for applying a release agent on the surface of a die, and drastically reducing a molding time.

In order to accomplish the above and other objects, according to a first aspect of the present invention, there is provided a method for producing an article made of plastics by an injection molding process. The method in accordance with the present invention comprises the steps of; providing a molding die assembly for molding a plastics material, comprising a first die and a second die, each having a molding surface, said first and second dies being adapted to be brought into a mating engagement wherein a molding cavity is formed between said first and second dies by respective molding surfaces, said first die being movable between a molding station where the first die is brought into said mating engagement with said second die and a coating station; heating said first die of said molding die assembly to a temperature of at least 50° C., placing said movable die at said coating station, and applying a liquid coating material on said molding surface of said movable die; moving said movable die to a drying chamber maintained at least at a temperature of 50° C. to have the coating material applied on said molding surface of the first die partially dried, and then to said molding station; bringing said first die into said mating engagement with said second die of said die assembly to form said molding cavity; and injecting molten plastics into said molding cavity to form a molded product having thereon a coating of said coating material.

According to a specific aspect of the present invention, a method for producing an article made of plastics by an injection molding process comprises; providing a molding die assembly for molding a plastics material, comprising a first die and a second die, each having a molding surface, said first and second dies being adapted to be brought into a mating engagement wherein a molding cavity is formed between said first and second dies by respective molding surfaces, said first die being movable between a molding station where the first die is brought into said mating engagement with said second die and a coating station; heating said first die of said molding die assembly at a temperature of 50 to 70° C., placing said first die at a coating station, and applying a liquid acrylic lacquer coating material on said molding surface of said first die; transferring said movable die to a drying chamber maintained at a temperature of 50 to 60° C., and maintaining said movable die in said drying chamber for 30 to 90 seconds to have said coating applied on said molding surface of the first molding die partially dried; transferring said first die to said molding station and bringing said first die into mating engagement with said second die of said die assembly to form a molding cavity between the respective molding surfaces of said first and second dies; and injecting a molten plastics material into said molding cavity to form a molded product having an acrylic lacquer coating on its surface.

According to a further specific aspect of the present invention, a method for producing an article made of plastics by an injection molding process comprises; providing a molding die assembly for molding a plastics material, comprising a first die and a second die, each having a molding surface, said first and second dies being adapted to be brought into a mating engagement wherein a molding cavity is formed between said first and second dies by respective molding surfaces, said first die being movable between a molding station where the first die is brought into said mating engagement with said second die and a coating station; heating said first die of said molding die assembly at a temperature of 60 to 95° C., placing said first die at said coating station and applying a coating of a liquid urethane-based or epoxy-based coating material on said molding surface of said first die; transferring said first die to a drying chamber maintained at a temperature of 80 to 90° C., and maintaining said first die in said drying chamber for 6 to 30 seconds to have said coating applied on said molding surface of said first die partly dried; transferring said first die to said molding station and bringing said first die into mating engagement with said second die of said die assembly to form a molding cavity between the respective molding surfaces of said first and second dies; and injecting a molten plastics material into said molding cavity to form a molded product having a coating of said coating material on its surface.

In the method of the present invention, the coating material may be applied at a film thickness of 6 to 20 μm. According to a further aspect of the present invention, the heating step may be carried out in the molding station. the first die may be maintained in the drying chamber for any predetermined time so that the coating material applied on said molding surface of the first die is partially dried. The first die may be movable in a vertical direction for bringing the first and second dies into the mating engagement.

According to the present invention, a plastics material is injected after a liquid coating material is applied on the molding surface of the first die and the first die is transferred to the drying chamber maintained at a temperature of 50° C. or more to have the coating material applied on the molding surface partly dried. Thus, irrespective of the type of coating material to be used, the adherence between the injection-molded plastics and the coating of the material can be adequately maintained without any risk that the coating of the applied coating material is disarranged by the injected flow of plastics. Further, the temperature of the movable die in the process of applying the coating material, the temperature of the drying chamber, and the drying time-period can be appropriately determined depending on the type of coating material to form an adequate coating or film irrespective of the types of coating material and the plastics to be used. Specifically, if the coating material is an acrylic lacquer coating, it can be applied to the first die heated at a temperature of 50 to 70° C., and dried in the drying chamber maintained at a temperature of 50 to 60° C. for 30 to 90 seconds, to obtain a satisfactory result. In the case where the coating material is of a urethane-based or epoxy-based type, it can be applied to the first die heated at a temperature of 60 to 90° C., and dried in the drying chamber maintained at a temperature of 80 to 90° C. for 6 to 30 seconds, to obtain a satisfactory result.

### BRIEF DESCRIPTION OF THE DRAWINGS

With reference to the drawings, one embodiment of the present invention will now be described. In the drawings;

FIG. 1 is a top plan view showing the structure and arrangement of an apparatus for use in a plastics material injection molding method of the present invention;

FIG. 2 is a side view of the apparatus shown in FIG. 1;

FIG. 3 is a top plan view showing a drying chamber and a coating station incorporated in the apparatus shown in FIG. 1; and,

FIG. 4 is a side view of the apparatus shown in FIG. 3.

### BEST MODE FOR CARRYING OUT THE INVENTION

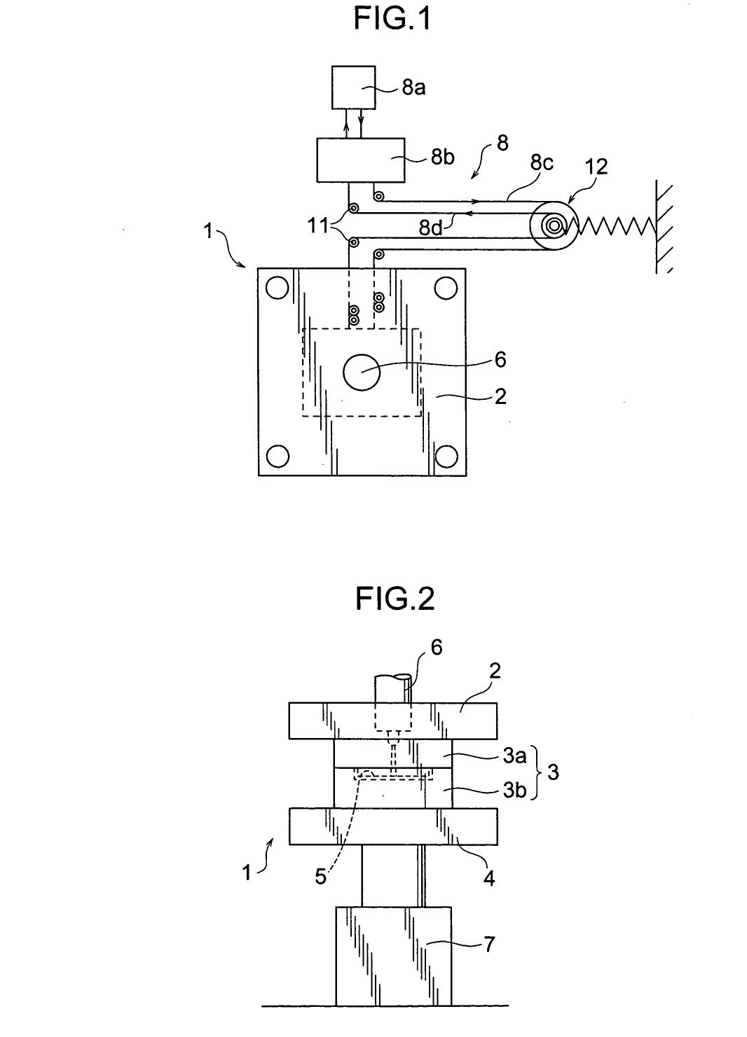

Referring to FIGS. 1 and 2, a plastics material-product injection molding apparatus 1 comprises a die assembly 3 including a stationary or upper die 3a fixed to a fixed plate 2 and a movable or lower die 3b attached to a movable plate 4. The die assembly 3 is designed to form a molding cavity 5 between the fixed die 3a and the movable die 3b when they are closed or brought into a mating engagement. For the purpose, as well known in the art, the both dies 3a and 3b have molding surfaces, respectively, to form the molding cavity 5 between the molding surfaces.

The fixed plate 2 supporting the stationary die 3a is provided with an injection cylinder 6 for injecting a molding plastics material in its molten state into the molding cavity 5 through the fixed die 3a. The movable plate 4 carrying the movable die 3a is supported by a die actuating cylinder 7 having parts telescopically movable in a vertical direction. The die actuating cylinder 7 is also movable horizontally as described later.

As shown in FIG. 1, a hot-water supply unit 8 is provided on the side of the die assembly 3. The hot-water supply unit 8 includes a water-heating device 8a such as a boiler, and a temperature control device 8b in fluid communication with the heating device 8a. The temperature control device 8b is operable to mix an appropriate amount of cold water with the hot water from the heating device 8a so as to adjust the temperature of the hot water at a given value and to supply only cold water from a water outlet thereof as needed.

The water outlet of the temperature control device 8b is in fluid communication with one of the ends of a supply hosepipe 8c. The other end of the supply hosepipe 8c is in fluid communication with a supply port of a water jacket (not shown) formed in the movable die 3b. The water circulated around the water jacket of the movable die 3b runs into an outlet port of the water jacket. The outlet port of the water jacket is in fluid communication with one or the ends or a return nosepipe 8b. The other end of the return hosepipe 8b is in fluid communication with a water return port of the temperature control device 8b.

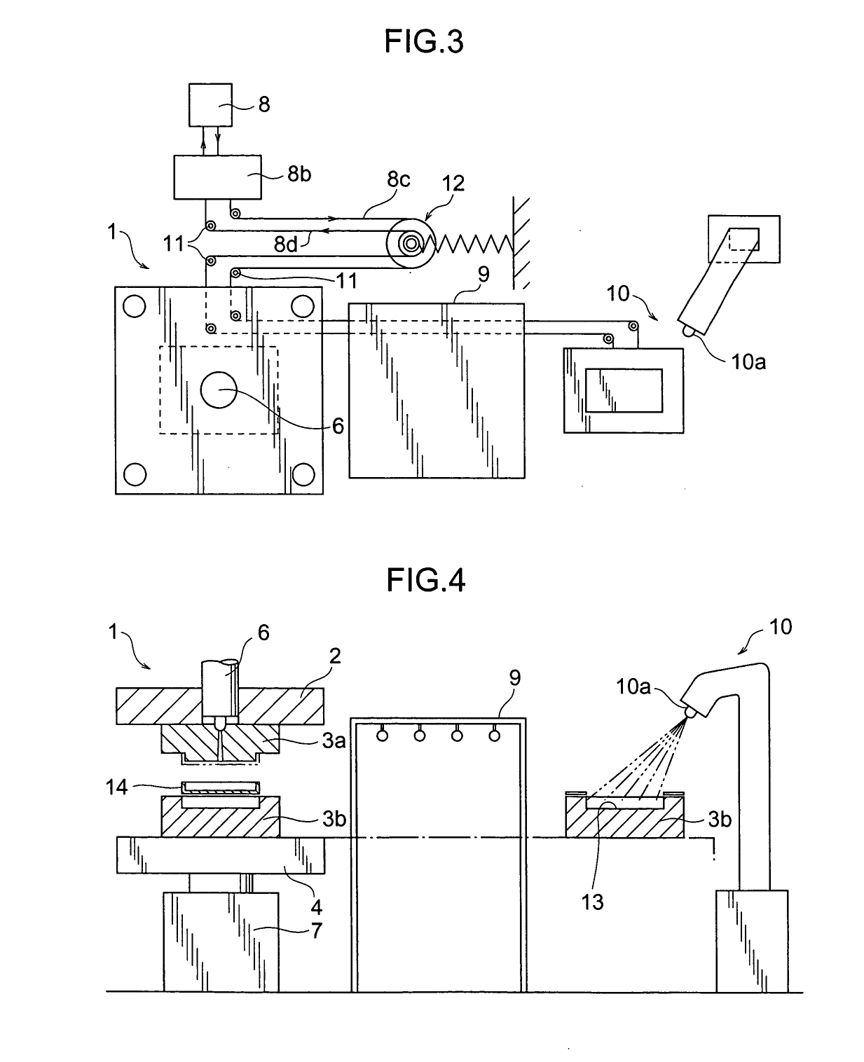

As shown in FIGS. 3 and 4, a drying chamber 9 is provided along the lateral side of the injection molding apparatus 1, and a coating station 10 is provided along the lateral side of the drying chamber 9. The die actuating cylinder 7 supporting the movable die 3a and the movable plate 4 is located such that it can be reciprocatingly moved to and from the coating station 10 through the drying chamber 9. Each of the hosepipes 8c, 8d between the temperature control device 8b and the movable die 3b has a length enough to allow the lateral movement of the movable die 3a. Further, an appropriate number of guide rollers 11 and a guide pulley 12 are provided to guide the hosepipes 8c, 8d. The guide pulley 12 is biased rightward in FIGS. 1 and 3 by a suitable biasing means to prevent the hosepipes 8c, 8d from going slack in the state illustrated in FIG. 1. The coating station 10 is provided with a coating-material splay nozzle 10a. During the process of applying a coating material to the movable die 3b at the coating station, the injection gate and other portions except the molding surface of the movable die 3b are masked by any suitable means such as a jig or the like. Such masking is advisable to prevent the coating material applied on the gate portion and such other portions from being allowed to flow into the molding cavity during the succeeding injection process and deteriorating the appearance of a molded product.

In an injection molding operation, a hot water adjusted at a given temperature of 50° C. or above is supplied from the temperature control device 8b of the hot-water supply unit 8 to the jacket of the movable die 3b to heat the movable die 3b up to a given temperature. The temperature of the movable die is set in the range of 50° C. to 70° C. if the coating material is an acrylic lacquer coating, or in the range of 60° C. to 95° C. if the coating material is a urethane-based or epoxy-based coating. The movable die heated in this manner is placed at the coating station 10, and the coating material is sprayed from the coating-material spray nozzle 10a to the molding surface 13 of the die 3b to form a film of the coating material on the molding surface 13. Preferably, the film has a thickness of 6 to 20 μm.

Then, the movable die 3b is moved through the drying chamber 9. The temperature of the drying chamber 9 is controlled in the range of 50° C. to 60° C. if the coating material is an acrylic lacquer coating, or in the range of 80° C. to 90° C. if the coating material is a urethane-based or epoxy-based coating. In this process, the movable die 3b is placed in the drying chamber 9 for a given time-period. This time-period is set in the range of 30 seconds to 90 seconds if the coating material is an acrylic lacquer coating, or in the range of 6 seconds to 30 seconds if the coating material is a urethane-based or epoxy-based coating.

Subsequently, the movable die 3b is transferred to the molding station wherein the die 3b is placed at a position below the fixed die 3a. Then, the movable die 3b is moved upward by the die actuating cylinder 7, and connected to the fixed die 3a to form the molding cavity 5. A plastics material in molten state is injected from the injection cylinder 6 into the molding cavity 5 to mold a plastics material product. The plastics material is not limited to specific one, but any suitable injection-moldable plastics material, such as ABS resin, polystyrene resin, polycarbonate resin or polypropylene resin may be used. Upon the completion of molding, a cold water is supplied from the temperature control device 8b to the jacket of the movable die 3b to cool the movable die 3b and the fixed die 3a. After the molding die assembly 3 is cooled to a given temperature, the movable die 3b is moved downward to open the molding die assembly 3, and the molded product 13 is taken out.

### EXAMPLE 1

The apparatus having the structure and arrangement illustrated in FIGS. 1 to 4 was prepared, and the processes were performed under the following conditions for spraying a coating material onto the molding surface of a movable die, drying the coating material, and injecting a plastics material to mold a molded product.

| | |
|---|---|
| Temperature of the movable die | 50° C. to 55° C. (plate type) |
| Coating material | PLANET SV (acrylic lacquer |
| | coating, available from Origin |
| | Electric Co., Ltd.) |
| Film thickness of coating material | 7 μm |
| Temperature of a drying chamber | 55° C. |
| Drying time-period | 60 seconds |
| Plastics material to be injected | ABS resin |

A product injection-molded under the above condition was checked. As a result, a coated film was uniformly formed on the surface of the product, and the adhesion between the coated film and the plastics material was in an acceptable level. Specifically, through a cross cut test in the general test procedures of coating according to JIS K 5400, the degree of adhesion in the product was determined as normal. Further, the product had a good appearance. In this example, the coated film was adequately formed without using any release agent.

### Comparative Example 1

A plastics material product was injection molded under the same conditions as those in Example 1 except for omitting the drying process. A coated film was disarranged due to the flow of injected plastics material, and the uniformity of the coated film on the product was in an unacceptable level.

### Comparative Example 2

A plastics material product was injection molded under the same conditions as those in Example 1 except for omitting the drying process and injecting the plastics material after the coating material was naturally dried to such a degree that no disarrangement was cased in a coated film. The total molding or process time was about 60 seconds longer than that in Example 1.

### Comparative Example 3

A plastics material product was injection molded under the same conditions as those in Example 1 except for setting the temperature of the movable die in the range of 30° C. to 40° C., omitting the drying process, and setting the time-period between the application of the coating material and the injection of the plastics material at 3 minutes. The uniformity of a coated film on the product was in an unacceptable level.

The present invention has thus been shown and described with reference to specific embodiments and examples, however, the invention is in no way limited to the details of the illustrated embodiments and examples but changes and modifications may be made without departing from the scope of the appended claims and equivalents.

1. A method for producing an article made of plastics by an injection molding process, the method comprising:
providing a molding die assembly for molding a plastics material, comprising a first die and a second die, each having a molding surface, said first and second dies being adapted to be brought into a mating engagement wherein a molding cavity is formed between said first and second dies by respective molding surfaces, said first die being movable between a molding station where the first die is brought into said mating engagement with said second die and a coating station;
heating said first die of said molding die assembly to a temperature of at least 50° C., placing said movable die at said coating station, and applying a liquid coating material on said molding surface of said movable die;
moving said movable die to a drying chamber maintained at least at a temperature of 50° C. to have the coating material applied on said molding surface of the first die partially dried, and then to said molding station;
bringing said first die into said mating engagement with said second die of said die assembly to form said molding cavity; and
injecting molten plastics into said molding cavity to form a molded product having thereon a coating of said coating material.

2. The method in accordance with claim 1 wherein said heating step is carried out in said molding station.

3. The method in accordance with claim 1 wherein said first die is maintained in said drying chamber for a predetermined time so that the coating material applied on said molding surface of the first die is partially dried.

4. The method in accordance with claim 1 wherein said first die is movable in a vertical direction.

5. The method in accordance with claim 1 wherein said liquid coating material is applied to said molding surface of said first die so that a coating of about 6 to about 20 μm (micro-meter) is formed.

6. A method for producing an article made of plastics through an injection molding process, the method comprising:
providing a molding die assembly for molding a plastics material, comprising a first die and a second die, each having a molding surface, said first and second dies being adapted to be brought into a mating engagement wherein a molding cavity is formed between said first and second dies by respective molding surfaces, said first die being movable between a molding station where the first die is brought into said mating engagement with said second die and a coating station;
heating said first die of said molding die assembly at a temperature of 50 to 70° C., placing said first die at a coating station, and applying a liquid acrylic lacquer coating material on said molding surface of said first die;
transferring said movable die to a drying chamber maintained at a temperature of 50 to 60° C., and maintaining said movable die in said drying chamber for 30 to 90 seconds to have said coating applied on said molding surface of the first molding die partially dried;
transferring said first die to said molding station and bringing said first die into mating engagement with said second die of said die assembly to form a molding cavity between the respective molding surfaces of said first and second dies; and
injecting a molten plastics material into said molding cavity to form a molded product having an acrylic lacquer coating on its surface.

7. The method in accordance with claim 1 wherein said liquid coating material is applied to said molding surface of said first die so that a coating of about 6 to about 20 μm (micro-meter) is formed.

8. A method for producing an article made of plastics through an injection molding process, the method comprising:
providing a molding die assembly for molding a plastics material, comprising a first die and a second die, each having a molding surface, said first and second dies being adapted to be brought into a mating engagement wherein a molding cavity is formed between said first and second dies by respective molding surfaces, said first die being movable between a molding station where the first die is brought into said mating engagement with said second die and a coating station;
heating said first die of said molding die assembly at a temperature of 60 to 95° C., placing said first die at said coating station and applying a coating of a liquid urethane-based or epoxy-based coating material on said molding surface of said first die;
transferring said first die to a drying chamber maintained at a temperature of 80 to 90° C., and maintaining said first die in said drying chamber for 6 to 30 seconds to have said coating applied on said molding surface of said first die partly dried;
transferring said first die to said molding station and bringing said first die into mating engagement with said second die of said die assembly to form a molding cavity between the respective molding surfaces of said first and second dies; and
injecting a molten plastics material into said molding cavity to form a molded product having a coating of said coating material on its surface.

9. The method in accordance with claim 8 wherein said liquid coating material is applied to said molding surface of said first die so that a coating of about 6 to about 20 μm (micro-meter) is formed.
